(19) United States
(12) Patent Application Publication
(10) Pub. No.: US 2006/0249008 A1
(43) Pub. Date: Nov. 9, 2006

(54) Training system for musical instruments

(76) Inventor: Martin Luther, Reidsville (CA)

Correspondence Address: JACOBSON HOLMAN PLLC, 400 SEVENTH STREET N.W., SUITE 600, WASHINGTON, DC, 20004, US

(21) Appl. No.: 11/397,898

(22) Filed: Apr. 5, 2006

(30) Foreign Application Priority Data
Apr. 6, 2005 (CA) 2,504,004

(51) Int. Cl. G10H 7/00

(52) U.S. Cl. 84/602

(57) ABSTRACT

The present invention provides a training system for musical instruments. A method for using the system and the component devices are also provided. The invention facilitates a user's understanding of the proper finger positions required when instruments are played, without the need for written sheet music instructions. The system comprises a modified musical instrument having a plurality of tone-producing elements corresponding to specific sounds or notes, a plurality of controllable instruction indicators on the modified musical instrument for indicating one or more elements to be activated by a user, a plurality of finger indicators for indicating one or more fingers to be used by the user to activate one or more of the elements of the musical instruments, a control means in communication with the controllable instruction indicators on the modified musical instrument for providing a signal to the one or more elements, a storage means for storing information, a display means for providing instruction information to the user, and an information retrieval means for communicating with one or more of the control means, the storage means and the display means.

### BACKGROUND OF THE INVENTION

1. Field of the Invention

This invention relates to musical instrument training systems. More specifically, the invention relates to a system for teaching a person a proper placement of fingers on an instrument, whether a stringed, a keyed or a button-operated instrument. Further, the invention relates to a method of using the system.

2. Description of the Prior Art

A variety of teaching systems and devices have already been devised to encourage and assist a beginner to in the process of learning to play notes, chords and scales on a musical instrument. Examples of prior art in this area include U.S. Pat. Nos. 6,634,886 (Oyama et al.), 6,087,577 (Yahata et al.), 6,452,081 (Ravagni et al.), 6,225,544 (Sciortino), 5,655,910 (Troudet) and 4,281,579 (Bennett Sr.). Other examples include Canadian Patent Nos. 1,269,242 (Pozzo), 1,136,405 (Bailon), 1,221,256 (Duffy) and 2,150,570 (Breitweiser). U.S. Pat. No. 5,920,023 (Ravagni et al.) is an example of a teaching aid based on fixed indicia, while most of the other references propose dynamic indicia.

U.S. Pat. No. 6,634,886 (Oyama et al.) describes an amusement system that includes a keyboard having a plurality of keys and a main control portion capable of instructing operation of the keyboard through a predetermined display device. An operation instructive portion has a plurality of regions associated with the user's fingers which are provided in a visually identifiable mode displayed on a screen of a display device.

U.S. Pat. No. 6,087,577 (Yahata et al) discloses a music navigator that provides a visual image indication or presentation of fingering motion of a hand when playing notes. In an embodiment, the music navigator employs a fingered music storage device and a hand image device. When music is played on a keyboard instrument, the music navigator reads fingered music data and selects appropriate hand image data indicative of a fingering motion (e.g., the turning over or under of a finger) in playing a current note for visual display. In another embodiment, the music navigator provides a sequence in a motion picture manner that displays hand images of a fingering motion in playing notes.

Canadian Patent No. 1,136,405 (Bailon) discloses an apparatus with a set of visual instructions.

Signalling lights are used with musical instruments to indicate the keys to be played and the desired degree of loudness or accent for a particular music piece. Instructions can be read from light emitting diodes (LED) incorporated in the frets of a guitar or the keys of a piano or a wind instrument. The instructions can also be read from the device itself, which can be placed on top of a piano or beside a guitar or wind instrument.

U.S. Pat. No. 6,452,081 (Ravagni et al.) discloses a device for teaching note locations and proper finger placement on the fingerboard of an instrument. The device may be adapted for use with either a fretted or non-fretted instrument. The device comprises a sheet of autogenously adhesive plastic, such as cling vinyl, with inset dynamically operated markers such as LED lamps or other electro-luminescent devices that indicate fingering locations for scales or chords. The synthetic target instrumental music is then rendered as one or more analog results, such as a score displayed on the computer screen or as a printed item, or recorded in the computer memory or as a MIDI output. Most importantly, the results can also be used to dynamically drive a set of illuminated “dots” removably attached to the finger board of a stringed instrument, thereby showing the novice player exactly where to place his fingers to produce the proper notes.

U.S. Pat. No. 6,225,544 (Sciortino) discloses a removably attachable musical instrument and illuminator positioning accessory which comprises at least one laser beam emitter. The emitter serves to illuminate a particular portion of the instrument, and in particular, to illuminate the area surrounding the point of contact between the musician's fingers and the instrument.

U.S. Pat. No. 4,281,579 (Bennett, Sr.) discloses a teaching aid for piano and other keyed musical instruments. The device includes switches electrically connected to a matrix array which are mechanically linked to each key to detect key depressions, an LED associated with each key to signal the keys to be played, and an alphanumeric display to show notes in literal and octave notation and the position of the student in a composition or exercise.

U.S. Pat. No. 5,655,910 (Troudet) describes a device that includes a dual set of hand/digit/phalange representations with indicia mounted thereon to provide pictorial and/or alphanumeric representations of a keyboard of arbitrary form and content. Such representations are adaptable to the growth, development, and preferences of the user, and can be used in the form of wearable devices such as gloves, digit-portions, and rings, non-wearable devices such as software-generated screen-displayed images, or hardware implementations that span planar and three-dimensional structures.

Thus, the above references teach a variety of systems to facilitate the identification of proper fingering for various types of instruments by indicating keys to be played or strings to be plucked, strummed or fingered through visual or aural means. Various hardware and software components and control systems are proposed.

While each of the above-noted references is of interest, there is still a need for a simple interactive system for use as a self-training tool by users who wish to play a musical instrument. A need exists for a system that reduces the need to understand written instructions, and functions with both stringed and non-stringed instruments.

### SUMMARY OF THE INVENTION

Accordingly, it is an object of the present invention to provide a system, method and devices that facilitate the user's understanding of the proper finger positions required when instruments are played, without the need for written sheet music instructions.

According to an aspect of the present invention, there is provided a system for musical instruments, the system comprising a modified musical instrument having a plurality of tone-producing elements corresponding to specific sounds or notes, a plurality of controllable instruction indicators on the modified musical instrument for indicating one or more elements to be activated by a user, a plurality of finger indicators for indicating one or more fingers to be used by the user to activate one or more of the elements of the musical instruments, a control means in communication with the controllable instruction indicators on the modified musical instrument for providing a signal to the one or more elements, a storage means for storing information, a display means for providing instruction information to the user, and an information retrieval means for communicating with one or more of the control means, the storage means and the display means.

In an embodiment of the aspect of the invention, one or more of the plurality of finger indicators are colour-coded and one or more of the controllable instruction indicators on the modified musical instrument are luminescent and colour-coded, the control means communicates with the controllable instruction indicators and with the display means, and the display means provides instruction information to the user. In another embodiment of the aspect of the invention, the modified musical instrument is an instrument with strings and a fingerboard.

In another embodiment of the aspect of the invention, the modified musical instrument is a guitar with controllable instruction indicators mounted on one or more of the body, the fingerboard and the neck.

In another embodiment of the aspect of the invention, the modified musical instrument has a keyboard.

In another embodiment of the aspect of the invention, the modified musical instrument has pressure-activated buttons or keys.

In another embodiment of the aspect of the invention, the information retrieval means is a hand-operated navigator.

According to a second aspect of the present invention, there is provided a system for musical instruments, the system comprising a modified musical instrument having a plurality of tone-producing elements corresponding to specific sounds or notes, a plurality of controllable instruction indicators on the modified musical instrument for indicating one or more elements to be activated by a user, a plurality of controllable finger indicators for indicating one or more fingers to be used by the user to activate one or more of the elements of the musical instruments, a control means in communication with the controllable instruction indicators on the modified musical instrument for providing a signal to the one or more elements, a storage means for storing information, and a display means for providing instruction information to the user.

In an embodiment of the second aspect of the invention, or more of the plurality of the controllable finger indicators and one or more of the controllable instruction indicators on the modified musical instrument are luminescent and colour-coded, the control means communicates with the controllable instruction indicators, the controllable finger indicators and the display means, and the display means provides instruction information to the user.

In another embodiment of the second aspect of the invention, the controllable finger indicators are placed on two hands of the user.

According to a third aspect of the present invention, there Is provided a method of facilitating the training of users who wish to play a musical instrument, comprising the steps of activating one or more of a plurality of controllable instruction indicators on a modified musical instrument; indicating one or more of a plurality of tone-producing elements corresponding to specific sounds or notes on the instrument; indicating one or more of a plurality of finger indicators to be used to activate one or more of the elements of the instrument; using a storage means, a control means in communication with the one or more controllable instruction indicators, a display means for providing instruction information to the user, and an information retrieval means for communicating with one or more of the control means, the storage means and the display means.

According to a fourth aspect of the present invention, there is provided a method for use of musical instruments, comprising displaying instruction information on a display means; activating one or more of a plurality of controllable instruction indicators on a modified musical instrument; indicating one or more of a plurality of tone-producing elements corresponding to specific sounds or notes on the instrument; and indicating one or more of a plurality of finger indicators to be used to activate one or more of the elements of the instrument.

According to a fifth aspect of the present invention, there is provided a method for using musical instruments, comprising placing finger indicators on fingers of one or two hands; viewing a display device; using a navigator to select a program from a library; starting a selected program musical sequence; signalling a wrist bracelet and finger indicators; signalling light indicators mounted at one or more of the neck, fingerboard, and body portions of the instrument; illuminating an arrangement of light indicators 52 on the fingerboard in a colour-coded combination; illuminating a selection of finger indicators; and cueing a correct placement of one or more fingers on the fingerboard hand at matching strings and frets.

### BRIEF DESCRIPTION OF THE DRAWINGS

The invention will be explained in more detail by way of the following description in conjunction with the drawings, in which:

FIG. 1 is a block diagram of an embodiment of the system of the invention;

FIG. 2 is a block diagram of a display screen menu for lesson types in an embodiment of the system of the invention;

FIG. 3 is a block diagram of a display screen menu for chord lessons in an embodiment of the system of the invention;

FIG. 4 is a block diagram of a display screen menu for bar chord lessons in an embodiment of the system of the invention;

FIG. 5 is a block diagram of a display screen menu for song lessons in an embodiment of the system of the invention;

FIG. 6 is a schematic illustration of a fingerboard hand of a user with finger indicator rings placed on the fingers in an embodiment of the system of the invention;

FIG. 7 is a perspective partial view of a guitar modified with light indicators in an embodiment of the system of the invention;

FIG. 8 is a cross-sectional view of the neck of the guitar of FIG. 7 with fret light indicators; and

FIG. 9 illustrates in detail a fret light indicator on the neck of the guitar of FIG. 8 as seen from the direction “X” on FIG. 4.

### DETAILED DESCRIPTION OF THE INVENTION

The system and method of the present invention is suitable for application with any musical instrument where a tone is activated by finger pressure on a string (guitar, violin), a key on a keyboard (piano, organ), or a key/button (accordion, trumpet, clarinet). The following description Illustrates the invention as embodied in relation to the strings and body of a guitar. Other embodiments can be readily adapted from the following description.

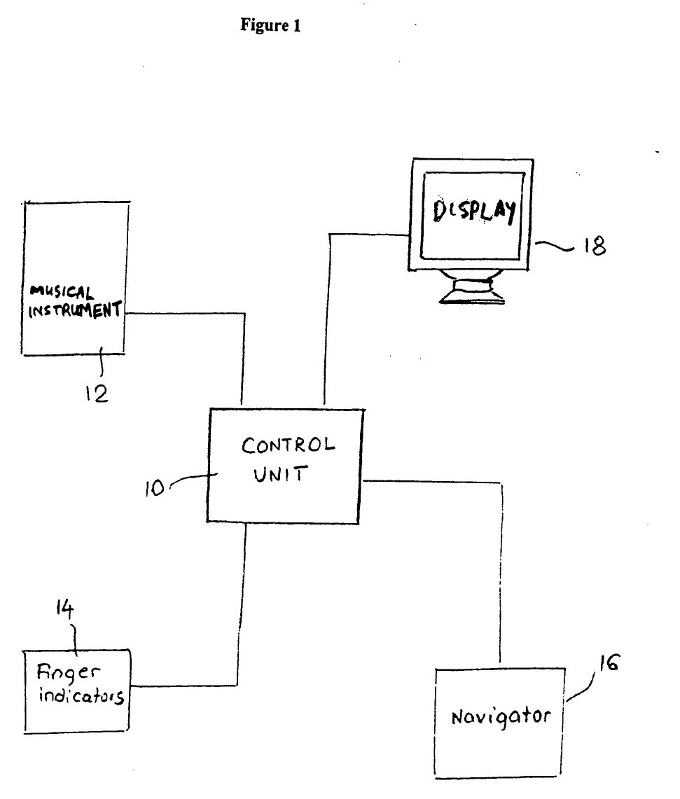

As represented schematically in FIG. 1, the system of the invention includes a control means such as a control unit 10, typically embodied by a computer built around a Central Processing Unit (CPU). The control unit 10 includes a library of playing instructions stored on computer readable storage media. These instructions provide the user with directions for placing his “fingerboard hand” on the fingerboard and his “soundboard hand” on the guitar soundboard. The instructions include the proper finger-fret (or finger-button or finger-key) positions for the fingerboard hand and the proper strumming direction for the soundboard hand. The instructions can be stored on a storage means such as a CD-ROM or other media. The storage media also stores input entered by the user, such as, for example guitar tabs or sound music.

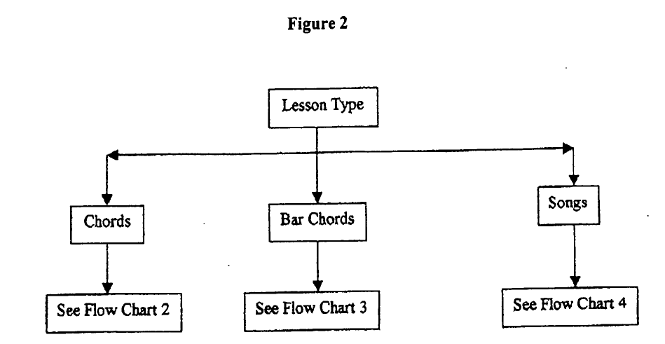

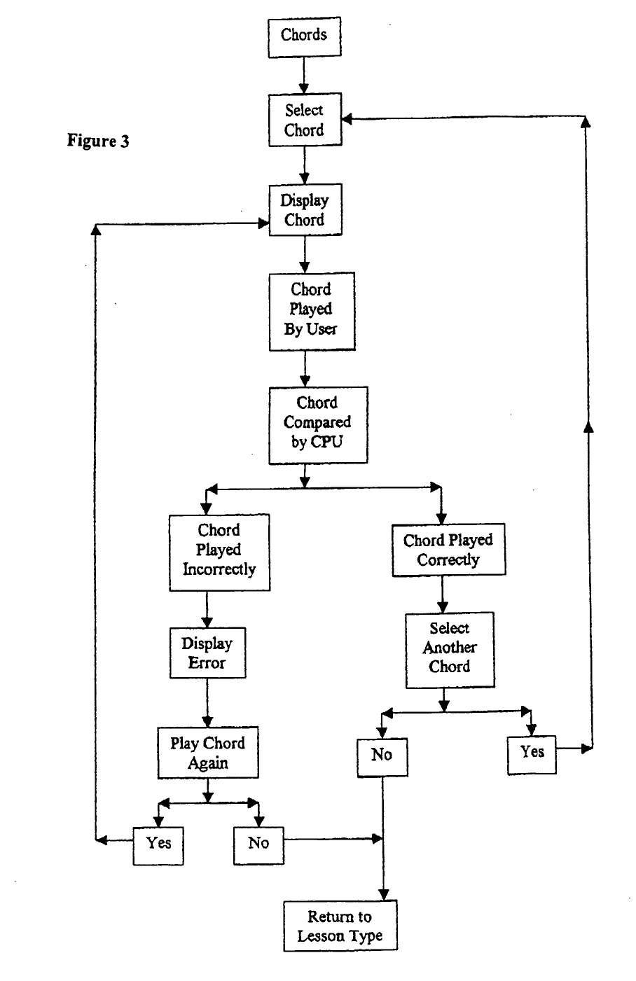

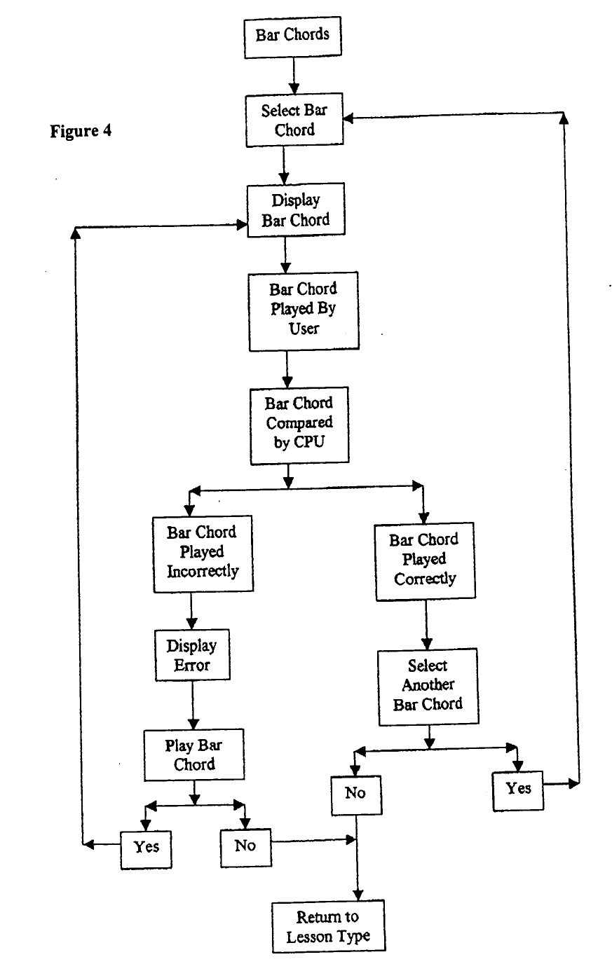

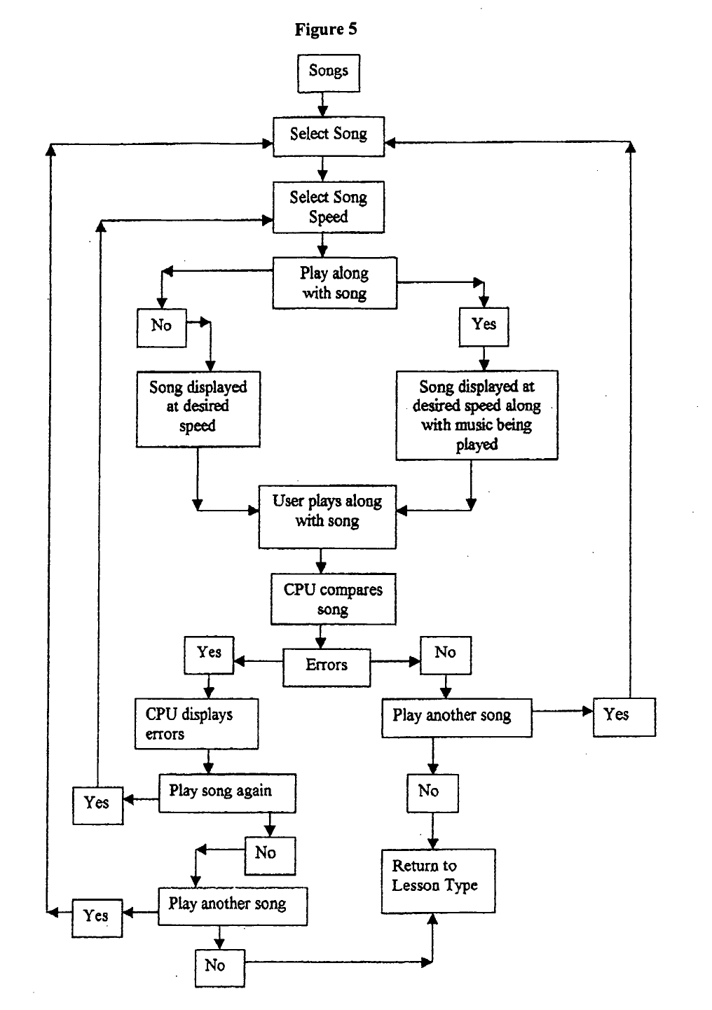

FIG. 1 shows the control unit 10 in communication with an information retrieval means (in this case, a navigator 16) and a display means, (here display device 18). Menu-driven display screens on the display device 18 present the user with instructions from the control unit 10. (Example menus for display screens are provided at FIGS. 2, 3, and 4 for illustrative purposes). The user then navigates through the display screens with the navigator 16 to select instructions. The display device 18 can be an LCD, plasma or other screen used in the computer hardware field. The navigator 16 can be a computer mouse, joystick, or other directing device used in the field.

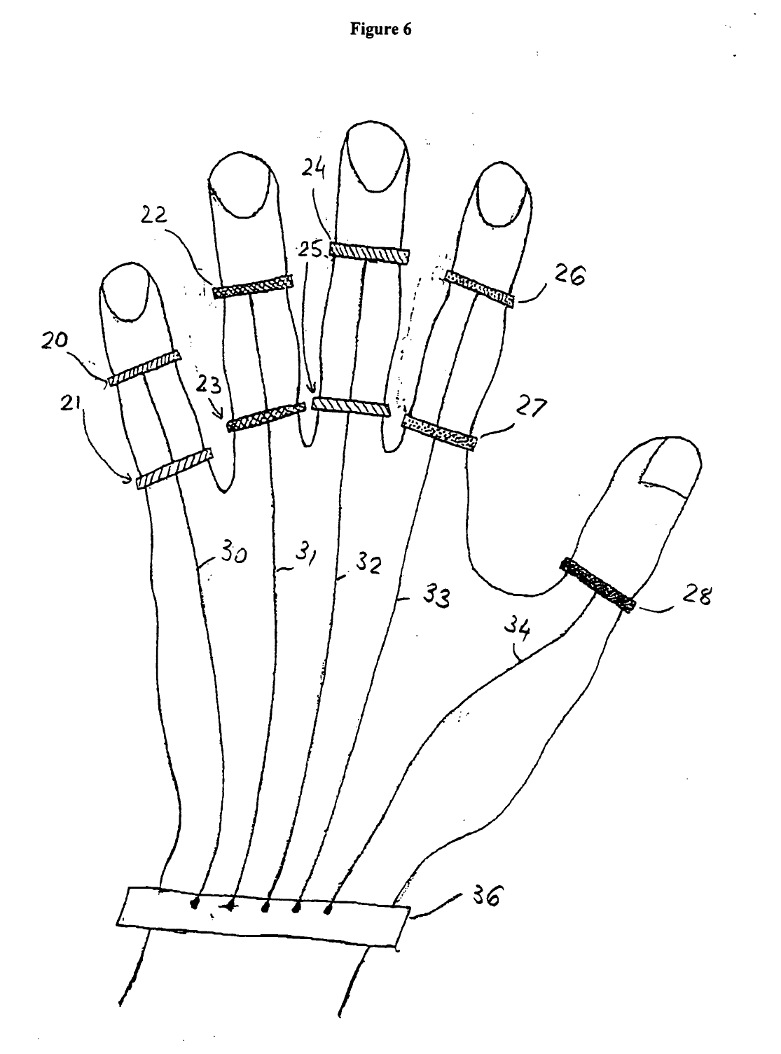

As shown in FIG. 1, the control unit 10 also communicates with a musical instrument 12. In the embodiment illustrated herein, the instrument Is a guitar modified in a manner explained hereinafter. The control unit 10 can also communicate with controllable finger indicators 14 placed on one or both of the user's hands. In the embodiment illustrated in FIG. 1 and FIG. 6, the control unit 10 communicates with finger indicators 14 through a wrist bracelet 36 placed on the fingerboard hand, shown here as the left hand. Although not shown here, the control unit 10 also communicates with finger indicators 14 on the soundboard hand. However, the system can achieve its objects even where no connection is provided between the control unit 10 and finger indicators 14 of either hand.

Communication between the control unit 10 and the external devices (the musical instrument 12, the display device 18, the navigator 16, and the finger indicators 14) can be provided several ways as are known in the field, including electrical wiring and remote radio frequency (RF) signals. The individual system components are described below, and the overall system is describe thereafter.

The embodiment in FIG. 6 illustrates the user's fingerboard hand in communication with the control unit 10 (not shown). In this example the left hand is used as the fingerboard hand. The finger indicators 14 are shown as colour-coded rings 20, 21, 22, 23, 24, 25, 26, 27, 28 placed on the fingers of the fingerboard hand. Two rings are placed on each finger, and one ring is placed on the thumb.

Each finger indicator 14 ring receives an individual signal from the control unit 10 (not shown). In this example, the control unit signal is received at a wrist bracelet, which transmits the information to each ring via electrical wires 30, 31, 32, 33, 34, thereby facilitating interactive communication with the control unit 10. The connection between the wrist bracelet 36 and the control unit 10 can be achieved either by physical connection, or by remote RF signal. In addition, the connection between the rings and the wrist bracelet 36 can be provided by either wires (as shown) or by a wireless RF or other connection.

While the fingerboard hand is illustrated as the left hand in FIG. 6, the right hand can also be used. The illustrated arrangement and the above-noted variations thereof can also be provided for the user's other hand (i.e., the soundboard hand). In that case, the same colour-coding scheme can be used for the rings on each finger of each hand. Although the finger indicators 14 are illustrated in FIG. 6 as rings, other embodiments of the invention can be used, such as pads or other materials. In embodiments where the finger indicators 14 are not configured to communicate electronically with the control unit 10, removable ink or other colour-coding schemes can be used on one or both hands to differentiate the fingers thereon.

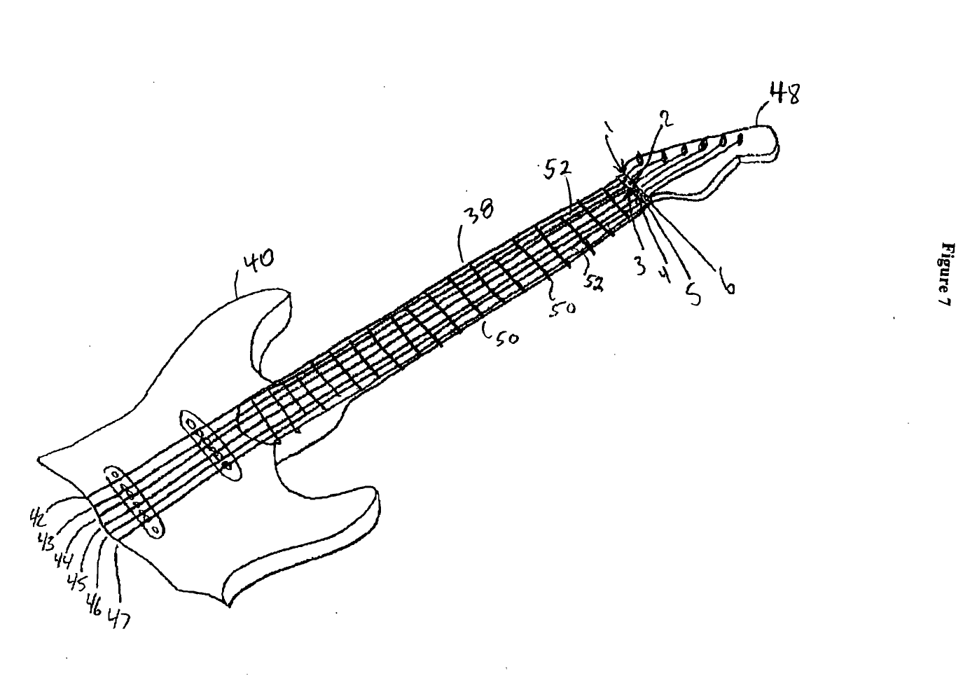

FIG. 7 illustrates the musical instrument 12 component of the invention using a modified guitar as an example. The guitar has a head 48 on a neck 38 affixed to a body 40. Six strings 42, 43, 44, 45, 46, 47 (the E, A, D, G, B, and E strings) are attached at the head 48 and at the body 40 (not shown). Controllable instruction indicators mounted on the guitar are electrically connected to the control unit 10 to provide luminescent colour-coded instructions to the user. Various configurations are described below.

In this example, two body-mounted light indicators 54, 56 indicate the proper strumming direction for the guitar strings 42, 43, 44, 45, 46, 47. Additional neck-mounted colour-coded light indicators 1, 2, 3, 4, 5, 6 are illuminated in series in the proper strumming direction to indicate the direction and number of strings that should be strummed or plucked. The body-mounted light indicators 54, 56 are shaped as arrows in this example, but other designs can also be used. Although this example illustrates a guitar that uses both the body-mounted light indicators 54, 56 and the neck-mounted colour-coded light indicators 1, 2, 3, 4, 5, 6, either set can be used without the other in other embodiments of the invention.

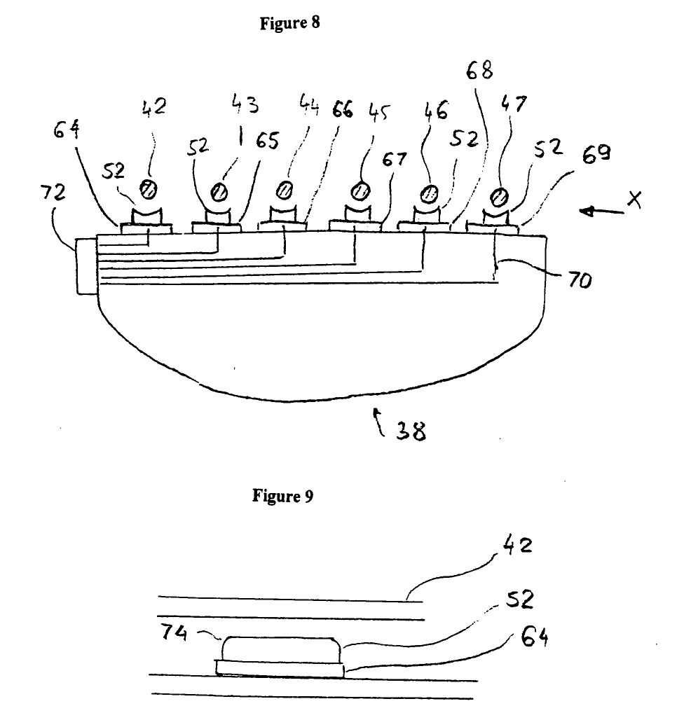

FIG. 7 also illustrates a fingerboard with twenty-one frets 50 mounted across the neck 38. The first, second and subsequent frets are numbered in ascending order from the nut at the head (the “zero” fret) on down the neck 38 toward the body 40. Fret light indicators 52 are mounted between each fret 50 substantially under the strings 42, 43, 44, 45, 46, 47. The arrangement of the fret light indicators is shown in more detail at FIG. 8 and FIG. 9.

FIG. 8 illustrates the neck 38 in detail in cross-sectional view from the head 48. Each section of the fingerboard, as partitioned by two frets 50, is divided into six sections 64, 65, 66, 67, 68, 69 across the neck 38. A controllable fret light indicator 52 is mounted over each of the six sections between the frets. A guitar string 42, 43, 44, 45, 46, 47 passes over each fret light indicator 52 and fits into a concave upper surface thereof when pressed into the fingerboard and the neck 38. The fret light indicator 52 is electrically connected to the control unit 10 via electric leads 70 and a pickup 72.

FIG. 9 illustrates a controllable fret light indicator 52 in cross-sectional view of as viewed across the neck 38 from the point marked “X” in FIG. 8. (The distances between the string 42 and the indicator 52 are not to scale). The fret light indicator 62 has a rounded end 74 in the string direction to permit the user's finger to glide easily along the string 42.

A variety of indicator configurations can be provided. The embodiment illustrated is based on a typical guitar with 21 frets and six strings. Accordingly, up to 126 colour-coded fret light indicators 52 can be included to describe each contact point on the strings between the frets. In addition, one or both of the two directional indicators 54, 56 on the body can be used, either with or without the six strumming/plucking indicators 1, 2, 3, 4, 5, 6 at the head 38. The indicator itself can be an LED, Cambridge Display element 52, fibre optic cable or other signalling device.

The components of the invention function in an integrated system as described for one embodiment below. When operating the above-described guitar-based embodiment, the user places the finger indicators 14 (in this case, the rings shown in FIG. 6) on the fingers of one or both hands. The user views the display device 18 and uses the navigator 16 to select a program from the library on the CPU. A starting musical sequence (for example, a chord) is selected and a set of electrical signals is sent from the control unit 10 to the wrist bracelet 16 and finger rings. A second set of signals is sent to the light indicators mounted at the neck, fingerboard, and body portions of the instrument.

The electrical signals illuminate a specific arrangement of the 126 fret light indicators 52 on the fingerboard in a colour-coded combination. A selection of finger rings are also illuminated with the colour combination at substantially the same time, thereby creating a visual cue to the user to place the correct finger of the fingerboard hand at the matching string and fret.

The control unit 10 also provides a signal to one of the body-mounted indicators 54, 56 to teach the proper direction in which to strum the strings. A colour-coded signal is sent to one or more of the neck-mounted light indicators 1, 2, 3, 4, 5, 6 at the head 38 to teach the proper string selection and sequencing in which the strings should be plucked or strummed by the soundboard hand.

The control unit 10 can be programmed to control the speed in which the signal combinations are provided, thus dictating the tempo of the chords or tones to be played.

The system can be used, for example, to teach the user how to play a D chord. The D chord is played by placing three fingers on the fingerboard hand between the appropriate frets 50. The G string is depressed by the index finger above the second fret, the B string is depressed by the ring finger above the third fret, and the E string is depressed by the middle finger above the second fret.

In the modified guitar shown at FIG. 7, the D chord can be identified on the fingerboard 38 with colour-coded fret light indicators 52 between the frets 50. A first indicator 52 can be illuminated in a colour code (for example, green) above the second fret of the G string 45, a second indicator 52 can be illuminated with a second colour (for example, blue) above the third fret of the B string 46, and a third indicator 52 can be illuminated with a third colour (for example, purple) above the second fret of the E string 47. All other light indicators 52 can be lit with a white colour to create visual contrast to the three other colours if such contrast is desired.

Next, colours marked on the finger indicators 14 of the fingerboard hand cue the user to play the D chord by matching his fingers to fret light indicators 52 illuminated with those same colours. These finger indicators 14 can also be illuminated if the embodiment thereof is structured to communicate with the control unit 10. In this example such communication is provided, and the finger indicators 14 are in the form of finger rings 20, 21, 22, 23, 24, 25, 26, 27 on a left fingerboard hand as shown in FIG. 6. The index finger upper ring 26 lights up green, the middle finger upper ring 24 lights up purple, and the ring finger upper and lower rings 22, 23 light up blue.

The user observes the colour-coded luminescent instruction indicators at the fret light indicators 52 and presses his fingers against the strings at the positions on the neck 38 indicated by the matching colours. As the fingers are depressed, the neck-mounted light indicators 1, 2, 3, 4, 5, 6 illuminate the desired strings 42, 43, 44, 45, 46, 47 and sequence in which they should be plucked or strummed. Body-mounted lights 54, 56 are illuminated to signal that the strings should be strummed in a downward motion by the soundboard hand. The user then strums the strings as indicated and the system records the sound generated. The user is then advised whether the chord was played correctly by the display device 18. Where the sound was not correct, the fingerboard fret light indicators 52 and the finger rings will flash to provide corrective instruction. In a preferred embodiment, the corrective instructions are preferably provided from both the display device 18 and the visual signals displayed on the fret light indicators 52 and the finger indicators 14. Any one or two of these three sets of signals can be used, as can other indicators, such as the body-mounted indicators 54, 56, or a sound signal or other indicator.

The system is interactive and allows a user to learn at his own pace by selecting playing arrangements that increase in complexity. Customized programs can also be used since the user can input and save their own data such as guitar tabs or sound music.

The embodiment described herein includes a modified guitar as one component, and the preferred embodiment describes the use of the system with a modified guitar configuration (with colour-coded luminescent controllable instruction indicators mounted at the neck, frets, and body) and a finger indicator configuration (with colour-coded luminescent controllable instruction rings on both hands in communication with the control unit). The system, components, and the method of use are not limited to these embodiments. Several other modifications to the guitar component are possible.

In addition, the system and method of the invention can be used with any number of modified non-stringed instruments. For example, the system can be used with a piano where the keys are modified with illuminated key indicators. To this end, colour-coded luminescent controllable instruction indicators connected to the control unit are placed at desired keys on a piano keyboard. Finger indicators, including colour-coded or other ring sets are placed on one or both of the user's hands. Predetermined signals in a pre-programmed database, e.g. a tone library, are then generated by the control unit and selected using the navigator or other information retrieval means. The user matches the colour of the ring on a specific finger with the colour of a light indicator associated with a key on the keyboard. A succession of tone-specific signals corresponding to a tone sequence (e.g. a melody) can thus be generated.

The system can also be used with a modified accordion or any other finger-activated instruments, whereby indicators on the playing surface (the keys, the buttons, etc.) are modified to display illuminated sequences as desired.

I claim:

1. A system for musical instruments, comprising:
a modified musical instrument having a plurality of tone-producing elements corresponding to specific sounds or notes,
a plurality of controllable instruction indicators on the modified musical instrument for indicating one or more elements to be activated by a user,
a plurality of finger indicators for indicating one or more fingers to be used by the user to activate one or more of the elements of the musical instruments,
a control means in communication with the controllable instruction indicators on the modified musical instrument for providing a signal to the one or more elements,
a storage means for storing information,
a display means for providing instruction information to the user, and
an information retrieval means for communicating with one or more of the control means, the storage means and the display means.

2. The system of claim 1, wherein one or more of the plurality of finger indicators is colour-coded and one or more of the controllable instruction indicators on the modified musical instrument is luminescent and colour-coded, and wherein the control means communicates with the controllable instruction indicators and with the display means, and the display means provides instruction information to the user.

3. The system of claim 1, wherein the modified musical instrument is an instrument with strings and a fingerboard.

4. The system of claim 1, wherein the modified musical instrument is a guitar with the controllable instruction indicators mounted on one or more of the body, the fingerboard and the neck.

5. The system of claim 1, wherein the modified musical instrument has a keyboard.

6. The system of claim 1, wherein the modified musical instrument has pressure-activated buttons or keys.

7. The system of claim 1, wherein the information retrieval means is a hand-operated navigator.

8. The system of claim 4, wherein two or more controllable instruction indicators are mounted on the guitar body to indicate a proper strumming direction for guitar strings.

9. The system of claim 8, wherein the body-mounted light indicators are arrow shaped.

10. The system of claim 4, wherein a controllable instruction indicator is mounted on the guitar neck over one of six sections of the fingerboard between frets, and can receive a guitar string passing over the indicator when pressed into the fingerboard.

11. A system for musical instruments, comprising:
a modified musical instrument having a plurality of tone-producing elements corresponding to specific sounds or notes,
a plurality of controllable instruction indicators on the modified musical instrument for indicating one or more elements to be activated by a user,
a plurality of controllable finger indicators for indicating one or more fingers to be used by the user to activate one or more of the elements of the musical instruments,
a control means in communication with the controllable instruction indicators on the modified musical instrument for providing a signal to the one or more elements,
a storage means for storing information, and
a display means for providing instruction information to the user.

12. The system of claim 11, wherein one or more of the plurality of the controllable finger indicators and one or more of the controllable instruction indicators on the modified musical instrument are luminescent and colour-coded, and wherein the control means communicates with the controllable instruction indicators, the controllable finger indicators and the display means, and the display means provides instruction information to the user.

13. The system of claim 11, wherein the controllable finger indicators are placed on two hands of the user.

14. A method of facilitating the training of users who wish to play a musical instrument, comprising the steps of:
activating one or more of a plurality of controllable instruction indicators on a modified musical instrument;
indicating one or more of a plurality of tone-producing elements corresponding to specific sounds or notes on the instrument;
indicating one or more of a plurality of finger indicators to be used to activate one or more of the elements of the instrument;
using a storage means, a control means in communication with the one or more controllable instruction indicators, a display means for providing instruction information to the user, and an information retrieval means for communicating with one or more of the control means, the storage means and the display means.

15. The method of claim 14, wherein one or more of the plurality of finger indicators is colour-coded and one or more of the controllable instruction indicators on the modified musical instrument is luminescent and colour-coded, and wherein the control means communicates with the controllable instruction indicators and with the display means, and the display means provides instruction information to the user.

16. The method of claim 14, wherein the modified musical instrument is an instrument with strings and a fingerboard.

17. The method of claim 14, wherein the modified musical instrument is a guitar with the controllable instruction indicators mounted on one or more of the body, the fingerboard and the neck.

18. The method of claim 14, wherein the modified musical instrument has a keyboard.

19. The method of claim 14, wherein the modified musical instrument has pressure-activated buttons or keys.

20. The method of claim 14, wherein the information retrieval means is a hand-operated navigator.
